(19) United States
(12) Patent Application Publication
(10) Pub. No.: US 2019/0287482 A1
(43) Pub. Date: Sep. 19, 2019

(54) COLOR CONVERSION APPARATUS, SIGNAL STANDARD CONVERSION APPARATUS, COLOR CONVERSION METHOD AND STORAGE MEDIUM

(71) Applicant: CANON KABUSHIKI KAISHA, Tokyo (JP)

(72) Inventor: Masahiko Mizoguchi, Yokohama-shi (JP)

(21) Appl. No.: 16/353,519

(22) Filed: Mar. 14, 2019

(30) Foreign Application Priority Data
Mar. 16, 2018 (JP) 2018-049796

(51) Int. Cl. G09G 5/02

(52) U.S. Cl. CPC G09G 5/02; G09G 2320/0666

(57) ABSTRACT

An object of the present invention is to suppress an arithmetic operation amount while preventing tone data missing with a desired accuracy in a case where gamma conversion whose nonlinearity is strong and color conversion are performed. The present invention is a color conversion apparatus including: a floating-point conversion unit configured to convert each piece of color data of a plurality of color components into common exponent part data and mantissa part data of each of the plurality of color components; a color conversion processing unit configured to perform color conversion for the mantissa part data of each of the plurality of color components and to output color conversion processing data; and a derivation unit configured to derive fixed-point data of each of the plurality of color components based on the color conversion processing data of each of the plurality of color components and the common exponent part data.

### BACKGROUND OF THE INVENTION

### Field of the Invention

The present invention relates to a color conversion apparatus, a signal standard conversion apparatus, a color conversion method, and a storage medium.

### Description of the Related Art

In recent years, by technical innovations in display devices, such as a video image display and a projector, it is made possible to display a higher luminance and higher dynamic range video image compared to that in a conventional CRT display. For example, the master monitor of a conventional CRT display (CRT master monitor) produces a display with a luminance of 100 nit (cd/m²) for 100% white of a video image signal, but it becomes common for a current display device to be capable of producing a display with a luminance of 100 nit or higher. Further, a display device called an HDR (High Dynamic Range) display capable of producing a display with a luminance of 1,000 to 4,000 nit has also appeared.

In order to produce a higher dynamic range video image display by using a display device, such as an HDR display, an HDR electro-optical transfer function (hereinafter, EOTF) Enabled to represent an HDR signal range by extending the EOTF has become necessary. The EOTF is the gamma standard of a display specified for a conventional SDR (Standard Dynamic Range) display.

As an example of the HDR EOTF, an HDR EOTF to which PQ (Perceptual Quantizer) that brings about a visually optimum quantization accuracy is applied has been standardized for a display luminance range up to 10,000 nit, Which is wider than a conventional range. The EOTF such as one represented by the PQ is an absolute luminance EOTF because it is specified as a quantization value for an absolute luminance at a video image output of the display device.

Further, as in the case with the luminance described above, the display devices are increasing in number whose color range (color gamut) that can be displayed becomes wider than conventionally. Image data whose color gamut is wide is called “wide color gamut image data”. There is an image capturing apparatus capable of generating wide color gamut image data by camera image capturing and printing the data. The wide color gamut image data has a color gamut specified by, for example, the BT.2020 standard. However, there is a video image display device capable of displaying the BT.2020 standard of the wide color gamut and on the other hand, there is a video image display device capable of displaying only the color gamut specified by the conventional narrow color gamut standard, for example, the BT.709 standard.

There is a case where a color signal exceeding the display performance of a display panel is input to a video image display device, and therefore, the processing is performed that adapts the color signal to the dynamic rage of the display panel by Detecting the maximum value of the three color signals of RGB and attenuating the maximum value to a level at which the maximum value can be displayed on the display panel. For example, the color signal conversion apparatus described in Japanese Patent Laid-Open No. 2008-271248 converts a video image signal from the outside into tone data of RGB linear to luminance by inverse gamma correction, performs color conversion and saturation conversion in accordance with the characteristics of the display device, and outputs the data after further performing gamma correction in accordance with the gamma characteristics of the display panel.

### SUMMARY OF THE INVENTION

In a case where color conversion in accordance with a display panel is performed, there is no problem in particular with the SDR OETF described previously. However, in a case where color conversion is combined with the HDR EOTF on the HDR display, for example, such as the PQ, the bit width required for the internal arithmetic operation will be a big problem. For example, in a case where it is assumed that an input signal that is input to inverse gamma correction has a 12-bit accuracy and an output signal that is output from gamma correction has 12-bit accuracy, the bit width of the internal arithmetic operation requires about 30 bits or more. The reason is that the characteristics of the PQ exhibit strong nonlinearity, and therefore, in order to prevent tone data missing with a desired accuracy in inverse gamma correction and gamma correction corresponding thereto, the number of bits will be required.

Consequently, in view of the above-described problem, An object of the present invention is to suppress the amount of arithmetic operation while preventing tone data missing with a predetermined accuracy in a case where gamma conversion whose nonlinearity is strong, such as a PQ curve, and color conversion are performed.

The present invention is a color conversion apparatus including: a floating-point conversion unit configured to convert each piece of color data of a plurality of color components into common exponent part data and mantissa part data of each of the plurality of color components; a color conversion processing unit configured to perform color conversion for the mantissa part data of each of the plurality of color components and to output color conversion processing data; and a derivation unit configured to derive fixed-point data of each of the plurality of color components based on the color conversion processing data of each of the plurality of color components and the common exponent part data.

Further features of the present invention will become apparent from the following description of exemplary embodiments with reference to the attached drawings.

### BRIEF DESCRIPTION OF THE DRAWINGS

FIG. 1A and FIG. 1B are each a block diagram of a video image signal standard conversion apparatus;

FIG. 2A and FIG. 2B are each a block diagram of a floating-point degamma processing unit;

FIG. 3 is a diagram showing tone characteristics of the ST.2084 standard;

FIG. 4A and FIG. 4B are each a diagram showing data conversion characteristics;

FIG. 5 is a block diagram of a common exponent part floating-point conversion unit in a first embodiment;

FIG. 6A to FIG. 6D are each a conceptual diagram of a floating-point representation in the first embodiment;

FIG. 7 is a block diagram of a floating-point gamma correction processing unit of the present invention;

FIG. 8 is a diagram showing characteristics of an exponent part determination unit in a third embodiment;

FIG. 9 is a block diagram of interpolation data conversion processing unit in the third embodiment; and

FIG. 10 is an example of reference data used in the third embodiment.

### DESCRIPTION OF THE EMBODIMENTS

### First Embodiment

### <About Configuration of Video Image Signal Standard Conversion Apparatus>

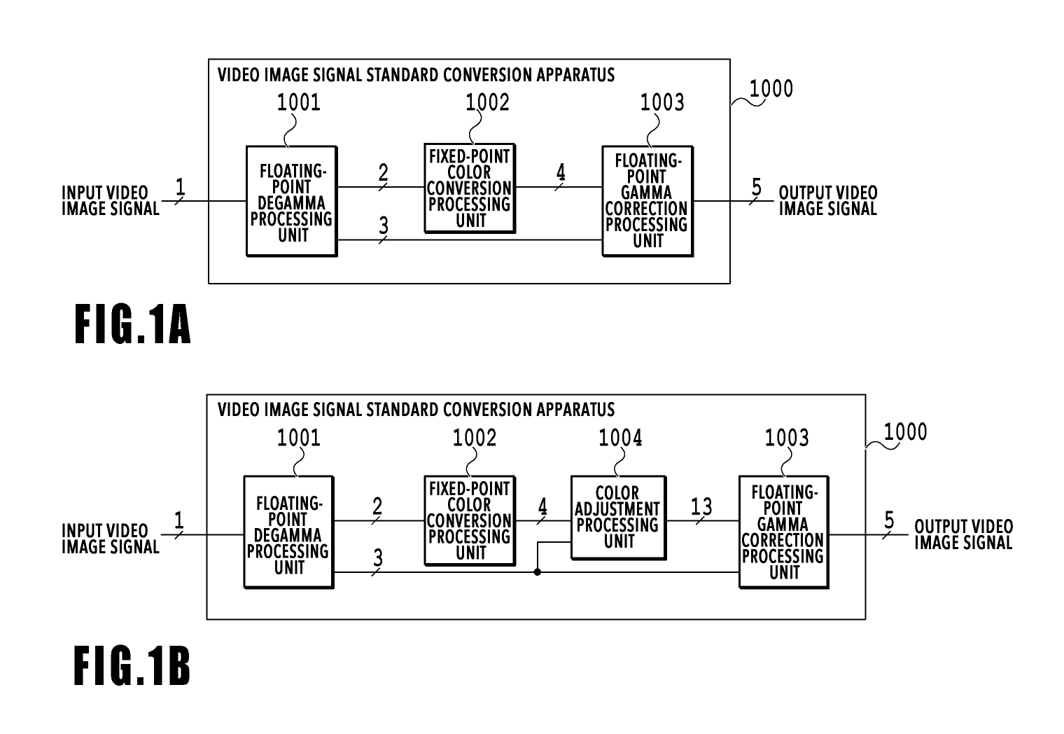

In the following, a video image signal standard conversion apparatus in the present embodiment is explained by using FIG. 1A. FIG. 1A is a block diagram showing an entire configuration of a video image signal standard conversion apparatus 1000, which is an image processing apparatus to which the present embodiment can be applied.

It is possible for the video image signal standard conversion apparatus 1000 to perform standard conversion processing of both or one of the gamma standard and the color standard, but here, It is assumed that the video image signal standard conversion apparatus 1000 performs only the conversion processing of the color standard.

It is assumed that the video image signal standard of an input video image signal 1, which is a signal that is input to the video image signal standard conversion apparatus 1000, is the first HDR standard and for example, The gamma standard is ST.2084 and the color standard is BT.709. In contrast to this, it is assumed that the video image signal standard of an output video image signal 5, which is a signal that the video image signal standard conversion apparatus 1000 outputs, is the second HDR standard and for example, the gamma standard is similarly ST.2804 and the color standard is BT.2020.

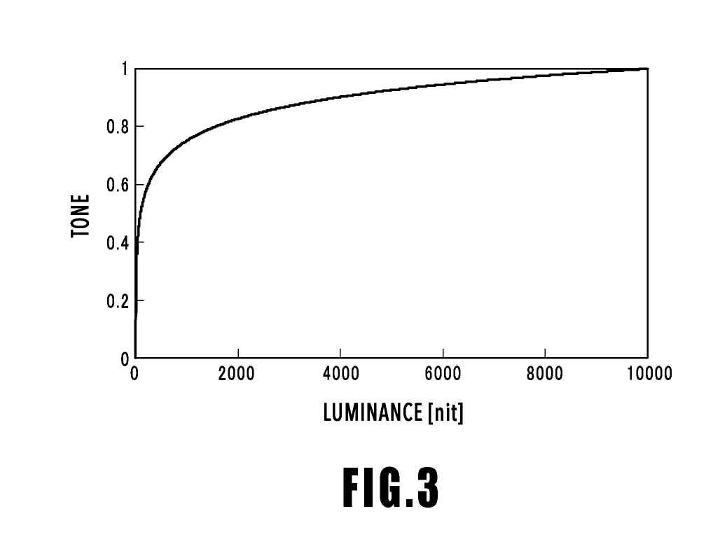

FIG. 3 shows EOTE tone characteristics of ST.2084. The tone characteristics are a relationship between the luminance, which is a physical quantity, and the tone, which is data used in an image processing apparatus or data of an input/output signal. In FIG. 3, the tone value is shown after standardization is performed so that a luminance of 10,000 [nit] corresponds to a tone of 1.0. The video image signal handled here is data of three components corresponding to the three primary colors RGB and the data of each component indicates tone information on the relevant color. Data of one pixel includes color data of three components of the pixel (tone data, that is, each pixel value of RGB) and image processing of the entire video image is performed by processing the data of all the pixels.

### <About Degamma Processing>

A floating-point degamma processing unit 1001 within the video image signal standard conversion apparatus 1000 performs correction processing of inverse gamma characteristic (inverse characteristics of EOTF) of ST.2084, which is the gamma standard Of the input video image signal 1, as first gamma conversion processing. Specifically, the floating-point degamma processing unit 1001 converts RGB data of the input video image signal 1 into luminance-linear RGB tone data and outputs the converted data as color conversion input mantissa part data 2 to a fixed-point color conversion processing unit 1002 and as common exponent part data 3 to a floating-point gamma correction processing unit 1003. Here, “luminance linear” refers to that tone data and luminance information represented by the tone data are in a linear relationship. The common exponent part data 3 is one piece of exponent part data common to the color conversion input mantissa part data 2 including three components of RGB. As described above, in the present embodiment, the luminance-linear RGB tone data is handled as a floating-point number by using the color conversion input mantissa part data 2 and the common exponent part data 3, described previously.

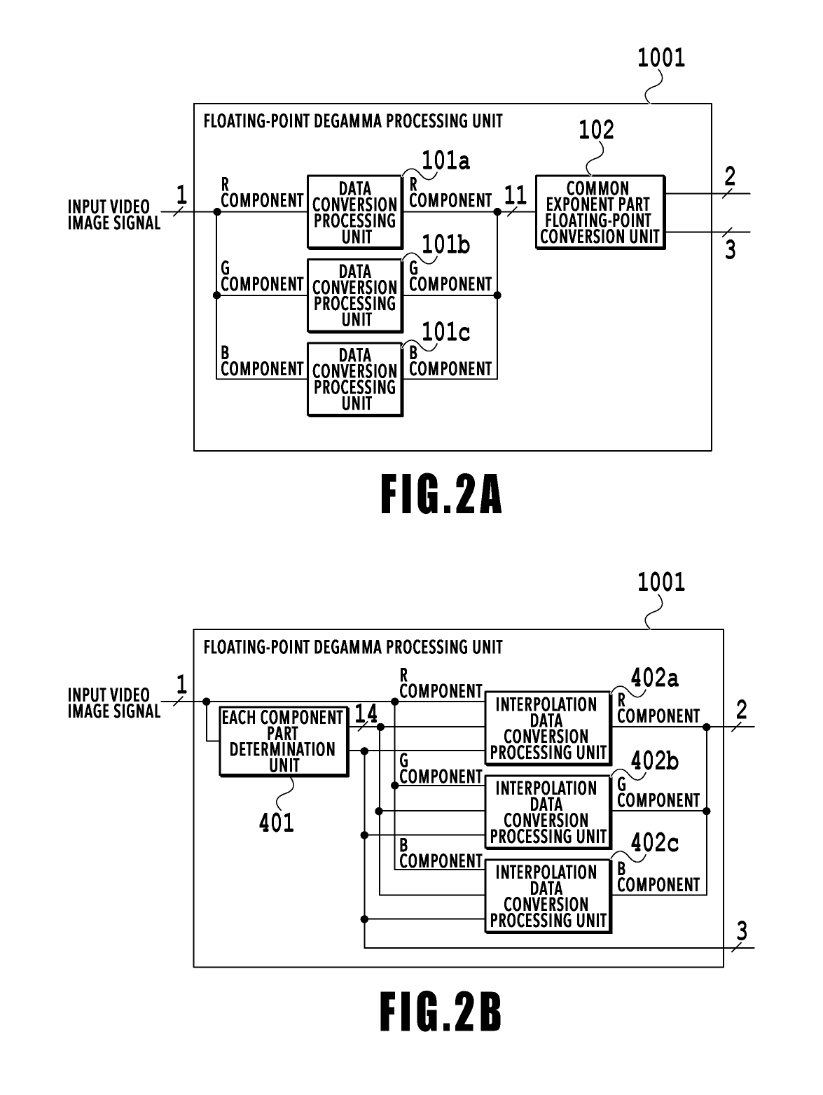

FIG. 2A is a block diagram showing a configuration of the floating-point degamma processing unit 1001 in the present embodiment. The input video image signal 1 includes three pieces of color data of the three primary colors of RGB and for each piece of the color data, gamma processing is performed in the corresponding data conversion processing unit. Specifically, for the color data of R, gamma processing is performed in a data conversion processing unit 101a, for the color data of G, in a data conversion processing unit 101b, and for the color data of B, in a data conversion processing unit 101c, respectively. The data that each of the data conversion processing unit 101a, the data conversion processing unit 101b, and the data conversion processing unit 101c outputs is data in the fixed-point format and input en bloc to a common exponent part floating-point conversion unit 102 as fixed-point luminance-linear data 11.

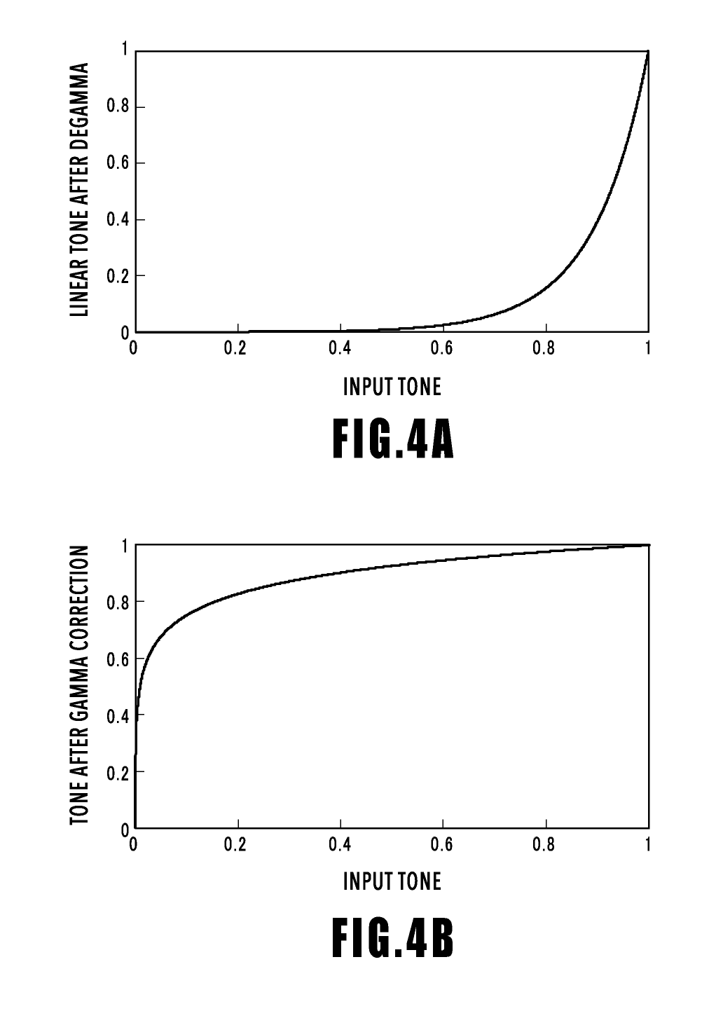

FIG. 4A shows conversion characteristics common to the three data conversion processing units, that is, the data conversion processing unit 101a, the data conversion processing unit 101b, and the data conversion processing unit 101c. In FIG. 4A, the maximum tone is standardized to 1.0 and the characteristics are inverse conversion characteristics (the vertical axis and the horizontal axis are exchanged and a luminance of 10,000 nit is represented by a tone of 1.0) of the tone characteristics of ST.2084 shown in FIG. 3. The fixed-point luminance-linear data 11 is data with a desired bit width, and for example, 32-bit width data. This is a bit width necessary to keep the conversion error to two tones or less in a case where the 12-bit width input video image signal 1 of the ST.2084 standard is converted into the 12-bit width output video image signal 5 of the ST.2084 standard by ideal degamma processing and gamma correction processing, to be described later.

### <About Common Exponent Part Floating-Point Conversion Unit>

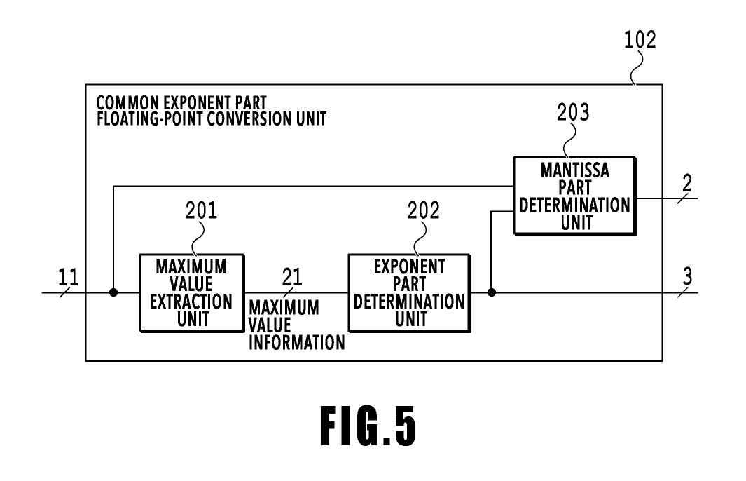

In a case where color conversion processing, to be described later, is performed by using the fixed-point luminance-linear data 11 with a great bit width as it is, the arithmetic operation circuit scale increases in accordance with the bit width. Because of this, in the present embodiment, in order to reduce the arithmetic operation circuit scale of color conversion processing, in the common exponent part floating-point conversion unit 102, the fixed-point luminance-linear data 11 is converted into the color conversion input mantissa part data 2 and the common exponent part data 3, both having a small bit width. FIG. 5 shows a block diagram of the common exponent part floating-point conversion unit 102.

A maximum value extraction unit 201 derives a maximum value from the three pieces of data, that is, the R component, the G component, and the B component of the fixed-point luminance-linear data 11 and outputs the maximum value to an exponent part Determination unit 202 as maximum value information 21. The exponent part determination unit 202 outputs the common exponent part data 3 based on the maximum value information 21. As a determination method of the common exponent part data 3, for example, the number of “0s” that continue from the most significant bit of the maximum value information 21 is taken to be the value of the common exponent part data 3. A mantissa part determination unit 203 determines the position of the mantissa part data in the fixed-point luminance-linear data 11 based on the common exponent part data 3 and outputs the color conversion input mantissa part data 2.

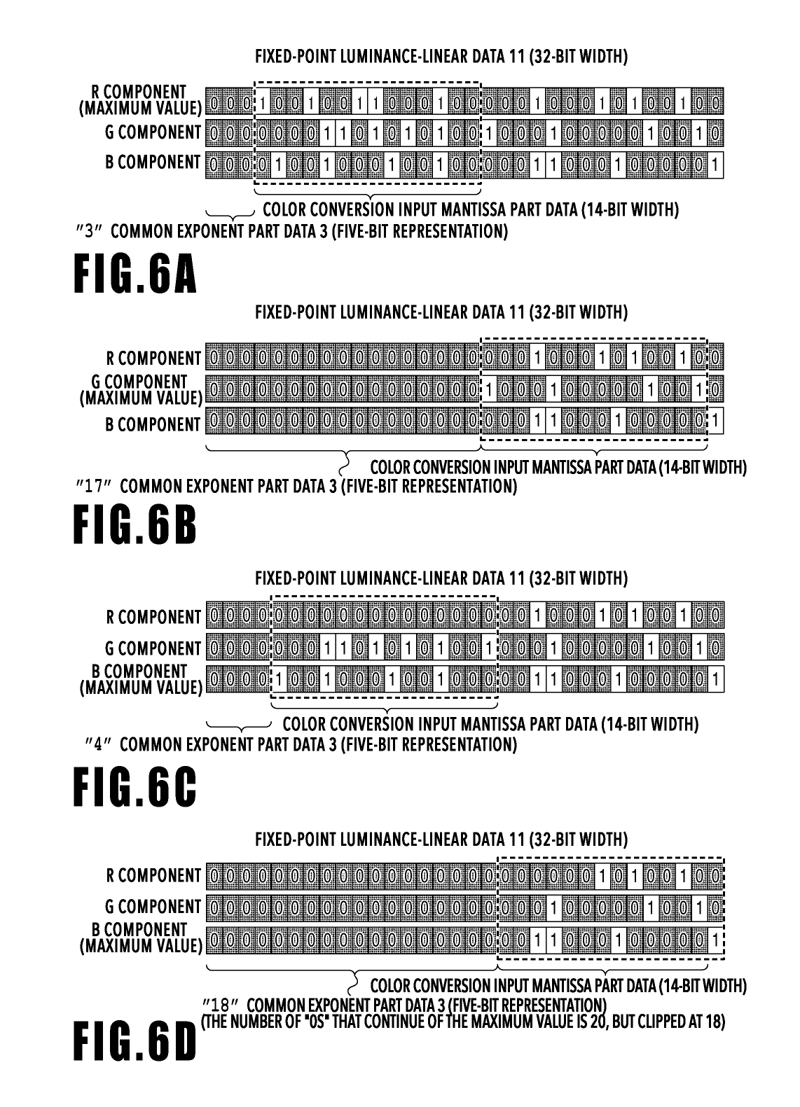

Specifically, the fixed-point luminance-linear data 11 is shifted to the left by an amount corresponding to the value of the common exponent part data 3 and a desired number of digits from the most significant bit is extracted. FIG. 6A to FIG. 6D show a conceptual diagram of conversion processing performed in the common exponent part floating-point conversion unit 102. The FIG. 6A to FIG. 6D show, as an example, a case where the fixed-point luminance-linear data 11 has a 32-bit width, the color conversion input mantissa part data 2 has a 14-bit width, and the common exponent part data 3 is a five-bit representation.

FIG. 6A shows a case where all the three color components are a high tone (high luminance). The color component that has the maximum value among the three color components is the R component and from this value, the common exponent part data 3 is “3” (the number of “0s” that continue from the most significant bit of the R component is “3”). Consequently, the bit width of the color conversion input mantissa part data 2 is a 14-bit width from the fourth bit from the most significant bit of the fixed-point luminance-linear data 11. In this case, the low-order bit data of all the color components of the fixed-point luminance-linear data 11, that is, low tone information (low luminance information) is lost, but the information is originally high luminance information, and therefore, the information that is lost is information in the area that is not visually recognized by human eyes. In a case where the video image signal standard conversion apparatus 1000 is connected to a display device or the like and the output video image signal 5 is input directly to the display device and used, no problem will occur.

FIG. 6B shows a case where all the three color components are a low tone (low luminance). The color component that has the maximum value of the three color components is the G component and from this value, the common exponent part data 3 is “17” (the number of “0s” that continue from the most significant bit of the G component is “17”). Consequently, the bit width of the color conversion input mantissa part data 2 is a 14-bit width from the 18th bit from the most significant bit of the fixed-point luminance-linear data 11. In this case, the low-order bit data of almost all the color components of the fixed-point luminance-linear data 11, that is, low tone information (low luminance information) is saved effectively. Consequently, in a case where the output video image signal 5 is input directly to the display device and used, it is made possible to represent low tone (low luminance area) information without a skip in tone or a shift in color.

FIG. 6C shows a case where a high tone (high luminance) and a low tone (low luminance) exist in a mixed manner in the three color components. The color component that has the maximum value of the three color components is the B component and from this value, the common exponent part data 3 is “4” (the number of “0s” that continue from the most significant bit of the B component is “4”). Consequently, the bit width of the color conversion input mantissa part data 2 is a 14-bit width from the fifth bit from the most significant bit of the fixed-point luminance-linear data 11. In this case, the low-order bit data (low tone, low luminance information) of the G component and the B component of the fixed-point luminance-linear data 11 is lost, but for the same reason as that in the case with FIG. 6A, there is no problem in the tone representation. However, on the other hand, low tone information of the R component is lost, and therefore, it seems that a problem will occur because the data of the R component has no high tone information. However, the degree of contribution of the R component is low at the time of performing color conversion by the matrix arithmetic operation of color conversion, to be described later, and for the same reason as in the case with FIG. 6A, even in a case where the R component of low tone (low luminance) disappears, this is not visually recognized (unlikely to be visually recognized) by human eyes because there are other color components of high tone (high luminance). Consequently, there is no problem in the tone representation.

FIG. 6D shows a case of a tone (luminance) lower than that in FIG. 6B. In this case, priority is given to securing the 14-bit width of the color conversion input mantissa part data 2, and therefore, the number of “0s” that continue from the most significant bit of the maximum value (B component) is “20”, but clipped at “18”. Consequently, the bit width of the color conversion input mantissa part data 2 is a 14-bit width from the least significant bit of the fixed-point luminance-linear data 11 and the common exponent part data 3 is “18”.

### <About Color Conversion Processing>

As already described, the color conversion input mantissa part data 2, which is input data of the fixed-point color conversion processing unit 1002, is luminance-linear data whose color standard is BT.709. On the other hand, color conversion output mantissa part data 4, which is output data (color conversion processing data) of the fixed-point color conversion processing unit 1002, is luminance-linear data whose color standard has become BT.2020 as a result of the color conversion processing being performed in the fixed-point color conversion processing unit 1002. All the color components of the color conversion input mantissa part data 2 and the color conversion output mantissa part data 4 are data of the floating-point representation, whose common exponent part data 3 is the exponent part. In a case where attention is focused on only the mantissa part data of the floating-point data, it is possible to interpret that the data is data of the fixed-point representation to which common gain (described as GAIN) represented by formula (1) is applied. In formula (1), DATA3 refers to the common exponent part data 3.

GAIN=2^{DATA3} [Mathematical formula 1]

Consequently, it is possible for the fixed-point color conversion processing unit 1002 to perform a color conversion arithmetic operation by a fixed-point matrix arithmetic operation for the color conversion input mantissa part data 2, Which is luminance-linear RGB data. The fixed-point color conversion processing unit 1002 outputs the color conversion output mantissa part data 4 as the results of the color conversion. An example of a specific arithmetic operation formula is shown in formula (2). In formula (2), DATA2 refers to the color conversion input mantissa part data 2 and DATA4 refers to the color conversion output mantissa part data 4. Further, for example, R_{DATA2} refers to the R component of the color conversion input mantissa part data 2. The matrix coefficient shown in formula (2) is described in the real number representation, but in a case where the matrix coefficient is implemented in hardware, it is assumed that the matrix coefficient is converted into fixed-point data with a desired bit width.

$$( \begin{matrix}{R}_{DATA 4} \\ {G}_{DATA 4} \\ {B}_{DATA 4}\end{matrix} ) = ( \begin{matrix}0.627 & 0.329 & 0.043 \\ 0.069 & 0.920 & 0.011 \\ 0.016 & 0.088 & 0.896\end{matrix} ) ( \begin{matrix}{R}_{DATA 2} \\ {G}_{DATA 2} \\ {B}_{DATA 2}\end{matrix} ) \qquad [ Mathematical formula 2 ]$$

### <About Gamma Correction Processing>

The floating-point gamma correction processing unit 1003 generates and outputs the output video image signal 5 by performing correction processing of gamma characteristics (EOTF itself) Whose gamma standard is ST.2084 based on the common exponent part data 3 and the color conversion output mantissa part data 4.

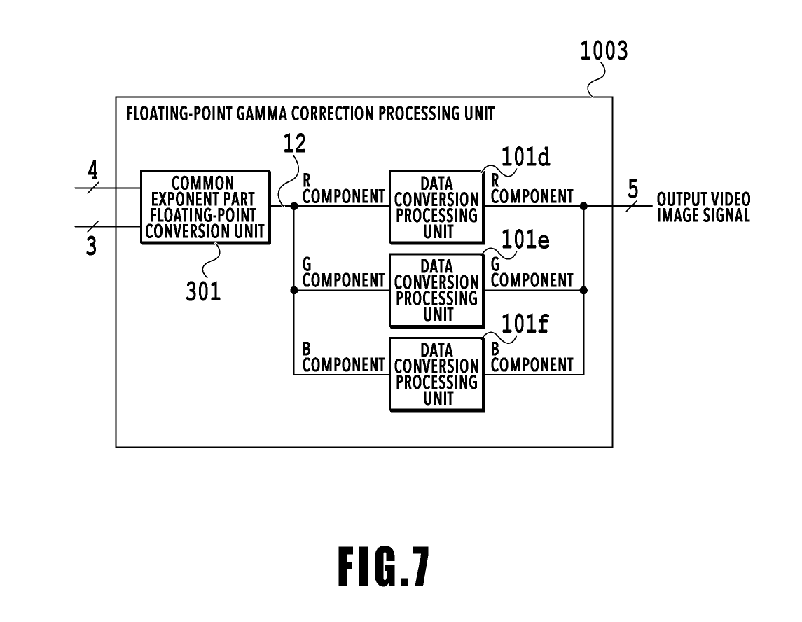

FIG. 7 is a block diagram showing a configuration of the floating-point gamma correction processing unit 1003 in the present embodiment. A common exponent part fixed-point conversion unit 301 outputs fixed-point color conversion output data 12 by processing represented by formula (3) based on the common exponent part data 3 and the color conversion output mantissa part data 4. In formula (3), DATA3 refers to the common exponent part data 3, DATA4 refers to the color conversion output mantissa part data 4, and DATA12 refers to the fixed-point color conversion output data 12.

$$( \begin{matrix}{R}_{DATA 12} \\ {G}_{DATA 12} \\ {B}_{DATA 12}\end{matrix} ) = {2}^{- DATA 3} \cdot ( \begin{matrix}{R}_{DATA 4} \\ {G}_{DATA 4} \\ {B}_{DATA 4}\end{matrix} ) \qquad [ Mathematical formula 3 ]$$

The fixed-point color conversion output data 12 is data with a desired bit width and for example, 32-bit width data. The reason is to suppress the conversion error to two tones or less as in the case with the fixed-point luminance-linear data 11.

Data conversion processing units 101d, 101e, and 101f within the floating-point gamma correction processing unit 1003 perform inverse conversion of the data conversion processing units 101a, 101b, And 101c within the floating-point degamma processing unit 1001. FIG. 4B is a diagram showing conversion characteristics common to the three data conversion processing units within the floating-point gamma correction processing unit 1003. In FIG. 4B, the maximum tone is standardized to 1.0 and the characteristics are equivalent to the tone characteristics of ST.2084 shown in FIG. 3 (a luminance of 10,000 nit is standardized to a tone of 1.0).

The output video image signal 5 generated as described above is output to a display device, such as a display, as it is, or after being converted into a predetermined digital video image transfer format.

### Second Embodiment

In the following, a case where the video image signal standard conversion apparatus further includes a color adjustment processing unit is explained. In the following, points different from the already-described embodiment are explained mainly and explanation of the same contents as those of the already-described embodiment is omitted appropriately.

FIG. 1B is a block diagram showing the entire configuration of the video image signal standard conversion apparatus 1000 in the present embodiment.

Compared to the first embodiment, to the video image signal standard conversion apparatus 1000 in the present embodiment, a color adjustment processing unit 1004 configured to perform tone offset processing is added. The tone offset processing is, for example, processing to add the same offset value to the R component, the G component, and the B component to increase a value in a low tone range. The offset value (described as OFFSET) used at the time of the tone offset processing is set in advance as a fixed value. Here, the color conversion output mantissa part data 4 that is output from the fixed-point color conversion processing unit 1002 in the present embodiment is the floating-point representation as described also in the first embodiment. Because of this, it is necessary to adjust the offset value in accordance with the common exponent part data 3. Consequently, by performing offset processing represented by formula (4), color adjustment data 13 is output. In formula (4), DATA3 refers to the common exponent part data 3, DATA4 refers to the color conversion output mantissa part data 4, and DATA13 refers to the color adjustment data 13.

$$( \begin{matrix}{R}_{DATA 13} \\ {G}_{DATA 13} \\ {B}_{DATA 13}\end{matrix} ) = ( \begin{matrix}{R}_{DATA 4} \\ {G}_{DATA 4} \\ {B}_{DATA 4}\end{matrix} ) + OFFSET \cdot {2}^{- DATA 3} \qquad [ Mathematical formula 4 ]$$

By performing this processing in advance, in a case where the floating-point number is returned to a fixed-point number by the floating-point gamma correction processing unit 1003, The same offset processing is performed in the individual pixels whose common exponent part data 3 is different.

In the subsequent processing, The floating-point gamma correction processing in the floating-point gamma correction processing unit 1003 is performed by using the color adjustment data 13 in place of the color conversion output mantissa part data 4 used in the first embodiment.

### Third Embodiment

In the following, a case where the configuration of the floating-point degamma processing unit is different from that of the first embodiment is explained. In the following, points different from the already-described embodiments are explained mainly and explanation of the same contents as those of the already-described embodiments is omitted appropriately.

### <About Degamma Processing>

The floating-point degamma processing unit 1001 in the present embodiment performs, as first gamma conversion processing, correction processing of inverse gamma characteristics whose gamma standard of the input video image signal 1 is ST.2084. Specifically, the floating-point degamma processing unit 1001 converts the RGB data of the input video image signal 1 into luminance-linear RGB tone data and outputs the converted data as the color conversion input mantissa part data 2 to the fixed-point color conversion processing unit 1002 and as the common exponent part data 3 to the floating-point gamma correction processing unit 1003.

FIG. 2B is a block diagram of the floating-point degamma processing unit 1001 in the present embodiment. As shown in FIG. 2B, the floating-point degamma processing unit 1001 in the present embodiment no longer has the common exponent part floating-point conversion unit 102 provided in the first embodiment, but each exponent part determination unit 401 is provided instead (see FIG. 2A). Further, in the floating-point degamma processing unit 1001 of the present embodiment, based on each piece of exponent part data determined in each exponent part determination unit 401, gamma conversion processing is performed in an interpolation data conversion processing unit 402 and the output of the interpolation data conversion processing unit 402 is the color conversion input mantissa part data 2. In the following, these components are described in detail.

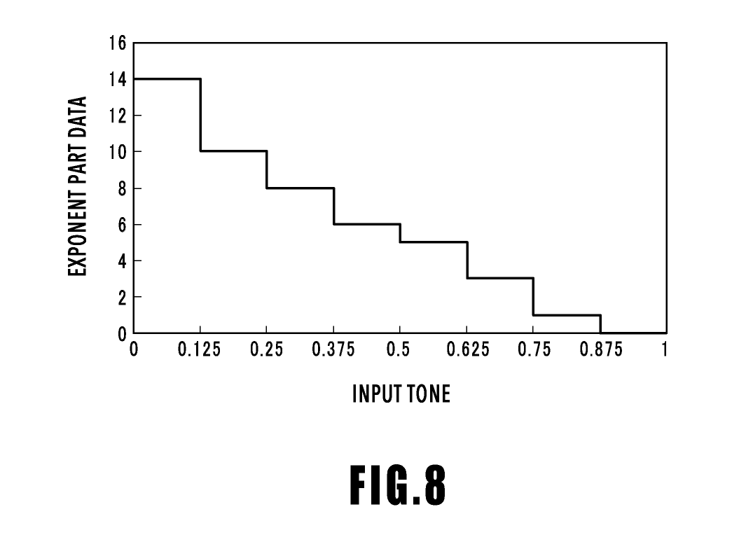

Each exponent part determination unit 401 determines the exponent part of each color component based on the input video image signal 1 data and outputs each color component exponent part data 14 (including each piece of data of the R component, the G component, and the B component) of the three channels. Further, each exponent part determination unit 401 outputs the minimum value of each color component exponent part data 14 as the common exponent part data 3. Here, in FIG. 8, the method of determining exponent part data in accordance with the data range of the input tone is shown as an example of the exponent part data determination method. The input tone of the horizontal axis in FIG. 8 is standardized so that the maximum tone is 1.0. For example, in a case where the input video image signal 1 is in the range from 0 to 0.125, the exponent part data is “14” and in a case where the input video image signal 1 is in the range from 0.25 to 0.375, the exponent part data is “8”.

The three interpolation data conversion processing units 402 have the common conversion characteristics and as in the case with the first embodiment, also have the characteristics of the common exponent part floating-point conversion unit 102 in the first embodiment, in addition to the characteristics shown in FIG. 4A. That is, different from the output of the data conversion processing unit 101 of the first embodiment, the output of the interpolation data conversion processing unit 402 is already mantissa part information and is the color conversion input mantissa part data 2 itself. The bit width is, for example, the 14-bit width as in the first embodiment.

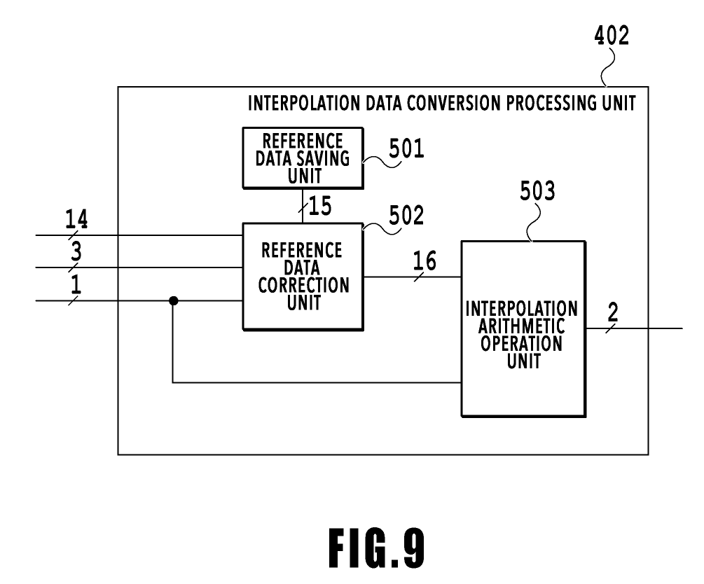

FIG. 9 shows a block diagram of the interpolation data conversion processing unit 402 that performs data conversion by interpolation processing.

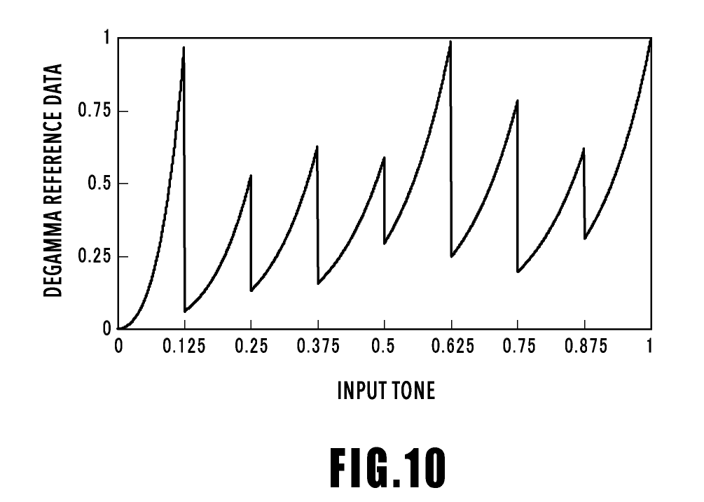

In a reference data saving unit 501, for example, table data of characteristics shown in FIG. 10 is saved and the reference data saving unit 501 outputs reference data 15 after degamma, which corresponds to the input video image signal 1, to a reference data correction unit 502. The characteristics are obtained by performing magnification correction for the degamma conversion characteristics in FIG. 4A in accordance with the exponent part data of the vertical axis in the characteristics diagram of the exponent part determination unit shown in FIG. 8. In this example, in a case where the input video image signal 1 is in the range from 0 to 0.125, the exponent part data is “14” and a value obtained by multiplying the linear tone data after the degamma in FIG. 4A by 2¹⁴ is the gamma reference data. Further, in a case where the input video image signal 1 is in the range from 0.25 to 0.375, the exponent part data is “8” and a value obtained by similarly multiplying the linear tone data by 2⁸ is the degamma reference data. The degamma reference data 15 generated in this manner is, in other words, already information corresponding to the mantissa part data, and therefore, in a case where the bit width of the color conversion input mantissa part data 2 is the 14-bit width, it is sufficient to save the 14-bit table data in the reference data saving unit 501 in accordance with this bit width. It is assumed that the table data is saved at predetermined grid intervals for the input video image signal 1 and data between grids is generated by an interpolation arithmetic operation, to be described later. By doing so, it is made possible to further reduce the table data amount to be saved.

The characteristics shown in FIG. 10 are equivalent to the conversion characteristics in the interpolation data conversion processing unit 402 in a case where all the tone data of the R component, the G component, and the B component of the input video image signal 1 is the same. The reason is that in a case where all the tone data of the R component, the G component, and the B component of the input video image signal 1 is the same, each color component exponent part data 14 and the common exponent part data 3 are identical to each other. On the other hand, in a case where the tone data of each color component of the input video image signal 1 is different, there is a possibility that each color component exponent part data 14 is different from the common exponent part data 3. Consequently, the degamma reference data is corrected in the reference data correction unit 502 so that the degamma reference data is identical to the common exponent part data 3. Specifically, as the results of arithmetic operation processing represented by formula (5) based on the degamma reference data 15, the common exponent part data 3, and each color component exponent part data 14, corrected degamma reference data 16 is output. In formula (5), DATA3 refers to the common exponent part data 3, DATA14 refers to each color component exponent part data 14, DATA15 refers to the degamma reference data 15, and DATA16 refers to the corrected degamma reference data 16.

$$DATA 16 = \frac{DATA 15}{{2}^{( DATA 14 - DATA 3 )}} \qquad [ Mathematical formula 5 ]$$

An interpolation arithmetic operation unit 503 performs a predetermined interpolation arithmetic operation by using the corrected degamma reference data 16 and the input video image signal 1 and generates and outputs the color conversion input mantissa part data 2.

### Summary, other Embodiments

The above explanation is given by using the preferred embodiment example for each embodiment of the present invention and the embodiment example is not intended to limit the present invention, and it is possible to easily apply a modification example of the present invention to a variety of aspects.

For example, in the embodiment described previously, the gamma standard of the input video image signal 1 and the output video image signal 5 is assumed to be ST.2084, which is one of the HDR standards, but the gamma standard may be another HDR standard, for example, HLG (hybrid log gamma) or a gamma standard proposed by each company. However, the effect of the present invention appears remarkably in a case where nonlinearity is stronger than the conventional SDR gamma standard.

Further, the gamma standard of both the input video image signal 1 and the output video image signal 5 is assumed to be ST.2084 of the HDR standard for both, but it is only required for at least one to be the HDR standard (gamma standard whose nonlinearity is strong) and the other may be another HDR standard or SDR standard.

Regarding the color standard, the color gamut standard of the input video image signal 1 is assumed to be BT.709 and the color gamut standard of the output video image signal 5 is assumed to be BT.2020, but each standard is not limited to those and it may also be possible to use any standard, such as AdobeRGR and BT.601. However, in a case where the color gamut of the input video image signal 1 is wider than the color gamut of the output video image signal 5, color data that cannot be represented only by a matrix arithmetic operation occurs, and therefore, a color matching technique using a 3D lookup table or the like becomes necessary separately. In using a 3D lookup table or in performing color matching processing, there is a case where absolute luminance information is necessary and such a case is dealt with by inputting the common exponent part data 3 to the color adjustment processing unit 1004 as in the second embodiment.

Although the detailed configuration of the data conversion processing unit 101 is not described, it is sufficient to adopt an appropriate publicly known technique in view of the arithmetic operation scale and the conversion performance. For example, it may also be possible to implement a theoretical formula for data conversion as it is, or to implement a formula approximate to the theoretical formula. Alternatively, it may also be possible to implement the table data and the various kinds of interpolation processing as described in the third embodiment. In a case where the interpolation processing is adopted, the grid intervals may be equal intervals, which are arbitrary intervals for the input tone as described in the third embodiment, or may be unequal intervals. Further, it may also be possible to save all the conversion data corresponding to the input tone as table data. In this case, it is possible to omit the interpolation arithmetic operation performed in the third embodiment. Further, as the interpolation processing method, it may be possible to adopt an appropriate publicly known technique in accordance with a desired data conversion accuracy. For example, there are linear interpolation, second-order approximation interpolation, third-order approximation interpolation, high-order interpolation, and so on.

Regarding the common exponent part data 3, the method of determining the common exponent part data 3 based on the maximum value of the tone data (RGB) for each pixel is described, but it may also be possible to determine the common exponent part data 3 for each predetermined area including a plurality of pixels or to determine the common exponent part data 3 across frames. Further, it may also be possible to use a predetermined fixed value in place of the maximum value. However, it these cases, there is a possibility that there occurs a case where it is not possible to save effective data (in particular, low tone) or a case where data saturates at the time of returning to a fixed-point number, and therefore, it is necessary to adopt an appropriate configuration from a relationship between processing performance and image quality.

Apparatuses, methods, and programs configured by combining the component, the function, the feature, or the arithmetic operation formula in each embodiment described previously are also included in the present embodiment.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

By the present invention, in a case where gamma conversion with strong nonlinearity and color conversion are performed, it is made possible to suppress the arithmetic operation amount while preventing tone data missing with a desired accuracy.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-049796, filed Mar. 16, 2018, which is hereby incorporated by reference wherein in its entirety.

What is claimed is:

1. A color conversion apparatus comprising:
a floating-point conversion unit configured to convert each piece of color data of a plurality of color components into common exponent part data and mantissa part data of each of the plurality of color components;
a color conversion processing unit configured to perform color conversion for the mantissa part data of each of the plurality of color components and to output color conversion processing data; and
a derivation unit configured to derive fixed-point data of each of the plurality of color components based on the color conversion processing data of each of the plurality of color components and the common exponent part data.

2. The color conversion apparatus according to claim 1, further comprising:
a determination unit configured to determine the common exponent part data in accordance with color data of the plurality of color components.

3. The color conversion apparatus according to claim 2, further comprising:
an extraction unit configured to extract a maximum value of color data of the plurality of color components, wherein
the determination unit determines the common exponent part data based on the maximum value.

4. The color conversion apparatus according to claim 3, wherein
the determination unit determines the common exponent part data in accordance with the number of 0s that continue from the most significant bit of data representing the maximum value.

5. The color conversion apparatus according to claim 1, wherein
the color conversion processing unit performs the color conversion by using a matrix arithmetic operation.

6. The color conversion apparatus according to claim 1, wherein
color data of the plurality of color components is data representing an image including a plurality of pixels.

7. The color conversion apparatus according to claim 6, wherein
the extraction unit extracts the maximum value for each pixel of the color data or for each predetermined area including a plurality of pixels in the color data.

8. The color conversion apparatus according to claim 1, further comprising:
a color adjustment processing unit configured to perform color adjustment processing using the common exponent part data for the color conversion processing data.

9. The color conversion apparatus according to claim 8, wherein
the color adjustment processing is tone offset processing.

10. The color conversion apparatus according to claim 1, wherein
the floating-point conversion unit converts input data into color data of the plurality of color components in accordance with a theoretical formula for converting data or an approximate formula of the theoretical formula, or by performing interpolation processing.

11. The color conversion apparatus according to claim 10, wherein
the floating-point conversion unit has mantissa part data used for the interpolation processing as table data and adjusts the mantissa part data in accordance with the common exponent part data.

12. The color conversion apparatus according to claim 1, wherein
each piece of color data of the plurality of color components is 32-bit width data.

13. The color conversion apparatus according to claim 1, wherein
the floating-point conversion unit converts at least one piece of color data of color data of the plurality of color components into exponent part data and mantissa part data by using exponent part data in accordance with another piece of color data.

14. The color conversion apparatus according to claim 1, wherein
the color conversion processing unit does not process the exponent part data.

15. The color conversion apparatus according to claim 1, wherein
the floating-point conversion unit uses a predetermined fixed value as the common exponent part data.

16. The color conversion apparatus according to claim 6, wherein
the floating-point conversion unit sets the common exponent part data for each area including a plurality of pixels.

17. The color conversion apparatus according to claim 1, wherein
the floating-point conversion unit shifts color data of each of the plurality of color components to the left by an amount corresponding to a value indicated by common exponent part data, extracts data with a predetermined number of digits, and does not extract data not included in the predetermined number of digits.

18. A signal standard conversion apparatus compatible with an HDR standard, including the color conversion apparatus according to claim 1.

19. A color conversion method comprising:
a step of converting each piece of color data of a plurality of color components into common exponent part data and mantissa part data of each of the plurality of color components;
a step of performing color conversion for the mantissa part data of each of the plurality of color components and outputting color conversion processing data; and
a step of deriving fixed-point data of each of the plurality of color components based on the color conversion processing data of each of the plurality of color components and the common exponent part data.

20. A non-transitory computer readable storage medium storing a program for causing a computer to perform a color conversion method comprising:
a step of converting each piece of color data of a plurality of color components into common exponent part data and mantissa part data of each of the plurality of color components;
a step of performing color conversion for the mantissa part data of each of the plurality of color components and outputting color conversion processing data; and
a step of deriving fixed-point data of each of the plurality of color components based on the color conversion processing data of each of the plurality of color components and the common exponent part data.
